(19) United States
(12) Patent Application Publication
(10) Pub. No.: US 2005/0246501 A1
(43) Pub. Date: Nov. 3, 2005

(54) Selective caching systems and methods

(75) Inventors: Vishal Batra, Bangalore (IN); Venkataraman Natarajan, Bangalore (IN)

Correspondence Address: JUNG-HUA KUO;C/O PORTFOLIOIP, P. O. BOX 52050, MINNEAPOLIS, MN, 55402, US

(73) Assignee: Intel Corporation, Santa Clara, CA (US)

(21) Appl. No.: 10/836,497

(22) Filed: Apr. 30, 2004

(51) Int. Cl. G06F 12/00

(52) U.S. Cl. 711/138

(57) ABSTRACT

Systems and methods are disclosed for performing selective caching in network processing and other contexts. In one embodiment, upon receipt of a processor's request for a data item, a determination is made as to whether the data item is stored in the processor's cache. If the data item is not stored in the cache, then the data item is retrieved from an external memory unit. If the retrieved data item meets certain predefined criteria, the data item is stored in the cache, where it replaces a least recently used cache entry. In one embodiment, the criteria that is used to determine whether data will be cached is whether the data is associated with a data connection having at least a predefined capacity. In one such embodiment, the predefined capacity is selected such that a cache hit multiplier is optimized.

### BACKGROUND

Advances in networking technology have led to the use of computer networks for a wide variety of applications, such as sending and receiving electronic mail, browsing Internet web pages, exchanging business data, and the like. As the use of computer networks proliferates, the technology upon which these networks are based has become increasingly complex.

Data is typically sent over a network in small packages called “packets,” which may be typically routed over a variety of intermediate network nodes before reaching their destination. These intermediate nodes (e.g., routers, switches, and the like) are often complex computer systems in their own right, and may include a variety of specialized hardware and software components.

For example, some network nodes may include one or more network processors for processing packets for use by higher-level applications. Network processors are typically comprised of a variety of components, including one or more processing units, memory units, buses, controllers, and the like.

A network processor will often be called upon to process packets corresponding to many different data streams. To do this, the network processor may process multiple streams in parallel, and may also be operable to switch between different stream contexts by storing the current processing state for a given stream, processing another stream or performing some other task, then restoring the processing context associated with the original data stream and resuming processing of that stream. The faster the network processor is able to perform its processing tasks, the faster the data streams that the network processor is handling will reach their destination, and the faster any business processes that rely on the data streams will be completed.

### BRIEF DESCRIPTION OF THE DRAWINGS

Reference will be made to the following drawings, in which:

FIG. 1 is a diagram of a network processor.

FIG. 2 shows an exemplary memory cache.

FIG. 3 is a flowchart of a method for using a cache such as that shown in FIG. 2.

FIG. 4 shows an illustrative system that utilizes selective caching techniques.

### DESCRIPTION OF SPECIFIC EMBODIMENTS

Systems and methods are disclosed for performing selective caching. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. For example, although several examples are provided in the context of Intel® Internet Exchange network processors, it will be appreciated that the same principles can be readily applied in other contexts as well. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

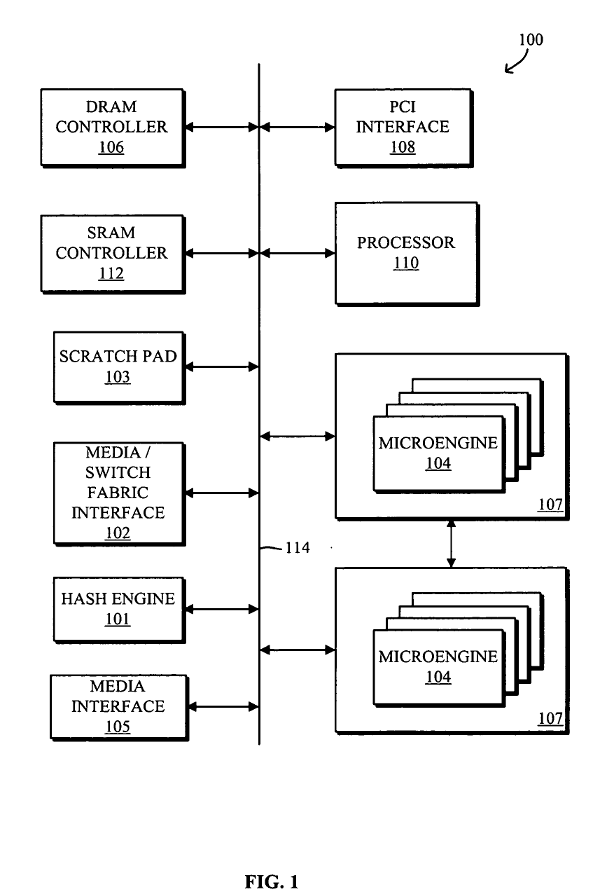

Network processors are used to perform packet processing and other networking operations. An example of a network processor 100 is shown in FIG. 1. The network processor 100 shown in FIG. 1 has a collection of microengines 104, arranged in clusters 107. Microengines 104 may, for example, comprise multi-threaded, Reduced Instruction Set Computing (RISC) processors tailored for packet processing. As shown in FIG. 1, network processor 100 may also include a core processor 110 (e.g., an Intel XScale® processor) that may be programmed to perform “control plane” tasks involved in network operations, such as signaling stacks and communicating with other processors. The core processor 110 may also handle some “data plane” tasks, and may provide additional packet processing threads.

Network processor 100 may also feature a variety of interfaces that carry packets between network processor 100 and other network components. For example, network processor 100 may include a switch fabric interface 102 (e.g., a Common Switch Interface (CSIX)) for transmitting packets to other processor(s) or circuitry connected to the fabric; a media interface 105 (e.g., a System Packet Interface Level 4 (SPI-4) interface) that enables network processor 100 to communicate with physical layer and/or link layer devices; an interface 108 (e.g., a Peripheral Component Interconnect (PCI) bus interface) for communicating with a host; and/or the like.

Network processor 100 may also include other components shared by the microengines 104 and/or core processor 110, such as one or more static random access memory (SRAM) controllers 112, dynamic random access memory (DRAM) controllers 106, a hash engine 101, and a relatively low-latency, on-chip scratch pad memory 103 for storing frequently used data. One or more internal buses 114 are used to facilitate communication between the various components of the system.

It will be appreciated that FIG. 1 is provided for purposes of illustration, and not limitation, and that the systems and methods described herein can be practiced with devices and architectures that lack some of the components and features shown in FIG. 1 and/or that have other components or features that are not shown.

As previously indicated, microengines 104 may, for example, comprise multi-threaded RISC engines having self-contained instruction and data memory to enable rapid access to locally stored code and data. Microengines 104 may also include one or more hardware-based coprocessors for performing specialized functions such as serialization, cyclic redundancy checking (CRC), cryptography, High-Level Data Link Control (HDLC) bit stuffing, and/or the like. The multi-threading capability of the microengines 104 may be supported by hardware that reserves different registers for different threads and can quickly swap thread contexts. The microengines 104 may communicate with neighboring microengines 104 via, e.g., shared memory and/or neighbor registers that are wired to adjacent engine(s).

In a system such as that described above, each microengine may be responsible for processing a large number of different connections at a single time. As a microengine switches back and forth between connections, it will often need to retrieve information regarding connections that was previously stored. All of this data may be stored in static or dynamic random access memory (SRAM or DRAM); however, retrieving data from SRAM or DRAM will generally be relatively time-consuming.

Thus, in one embodiment, the microengines make use of caching techniques to maintain a local store of the most frequently used data, thereby increasing each microengine's processing efficiency by decreasing the average amount of the time needed to retrieve data that has been previously stored.

Caching is used in many hardware and software contexts, and generally refers to the use of a relatively small amount of relatively fast memory to store data that is frequently used. By storing frequently used data in a low-latency cache, the number of times a processor must access data from relatively slow (high latency) sources like external SRAM or DRAM is reduced.

Caches typically have only a limited storage capacity, since they are often integrated with the processor itself. Thus, while ideally all data needed by the processor would be stored in cache, in reality this is impractical, since providing a cache of this size would be prohibitively expensive and/or infeasible given a typical processor's size constraints. Thus, techniques are needed for using the cache's limited amount of memory most effectively.

Several such techniques are presented below. In one embodiment, the microengines of a network processor such as that shown in FIG. 1 include a local, low-latency cache. If there are M entries in the cache and N data elements in the higher-latency memory devices available to the microengine (e.g., SRAM, DRAM, and the like), then the probability of a given data element being in the cache is M/N.

As previously indicated, one way to improve this probability is to increase M by, e.g., increasing the size of the cache. However, this will often be impractical, and, in any event, there will ultimately be some limit on how large M can be.

Thus, in one embodiment a selective caching technique is used to increase the probability of a desired piece of data being found in the cache (i.e., a “cache hit”) without changing M, which is assumed to be fixed. In accordance with this technique, data are only cached if certain criteria are satisfied, rather than blindly caching all data. The criteria can be based on patterns observed in the incoming data, and/or on other characteristics of the data and/or its context.

As previously indicated, a microengine will often receive data from multiple data streams or “pipes.” The higher the capacity of a data pipe, the greater the probability of receiving data on that pipe. Thus, in one embodiment a selective caching technique is used that only caches data associated with pipes having at least a minimum capacity (or bandwidth), C. Data received from pipes with a capacity less than C are not cached, but are instead dynamically loaded from, or sent to, relatively slow memory such as SRAM, taking care to maintain the atomicity of these operations if multiple contexts are acting on the data pipes in parallel. An advantage of this approach is that the cache is only used to store data that is most in need of caching.

The probability that a given piece of data will be found in the cache can be computed in the following manner. Assume that there are K data elements that are associated with data streams having a capacity greater than C (i.e., there are K cacheable data elements). If there is a total of N data elements, then N—K data elements are not cacheable. On average, if it is assumed that the capacity or data rate of the pipes associated with the K cacheable data elements is R times that of the N—K non-cacheable data elements, then the probability of a cache hit will be equal to the probability that a given piece of data is cacheable, multiplied by the probability that a given piece of data is in the cache. Namely, the probability of a cache hit, P(hit) is given by the following equation:

$$P ( hit ) = \frac{R * K}{( R * K ) + N - K} * \frac{M}{K}$$

This can be rearranged to yield:

$$P ( hit ) = \frac{R * K}{( R - 1 ) * K + N} * \frac{N}{K} * \frac{M}{N}$$

$$Or \text{:}$$

$$P ( hit ) = \frac{R * N}{( R - 1 ) * K + N} * \frac{M}{N}$$

The factor (R * N)/((R−1) * K+N) will be referred to as the cache hit multiplier, and can be tuned to be greater than 1 by carefully selecting K, where R is, by design, assumed to be greater than one. For example if R=2 and K=N/2, the value of the cache hit multiplier will be 4/3, representing a gain of 33%. That is, the cache hit multiplier represents the amount by which the probability of a cache hit is increased over the probability (i.e., M/N) that would obtain if selective caching were not used.

Thus, by optimizing the value of the cache hit multiplier, the average memory access time is decreased from that which would be achievable using a conventional caching algorithm, in which all data is cached without regard to the capacity of the data pipe with which it is associated. Moreover, by selectively caching based on data pipe capacity, it is possible to achieve better hit rates for the same number of cache entries. Put differently, the use of selective caching reduces the cache memory requirements for achieving a given hit rate.

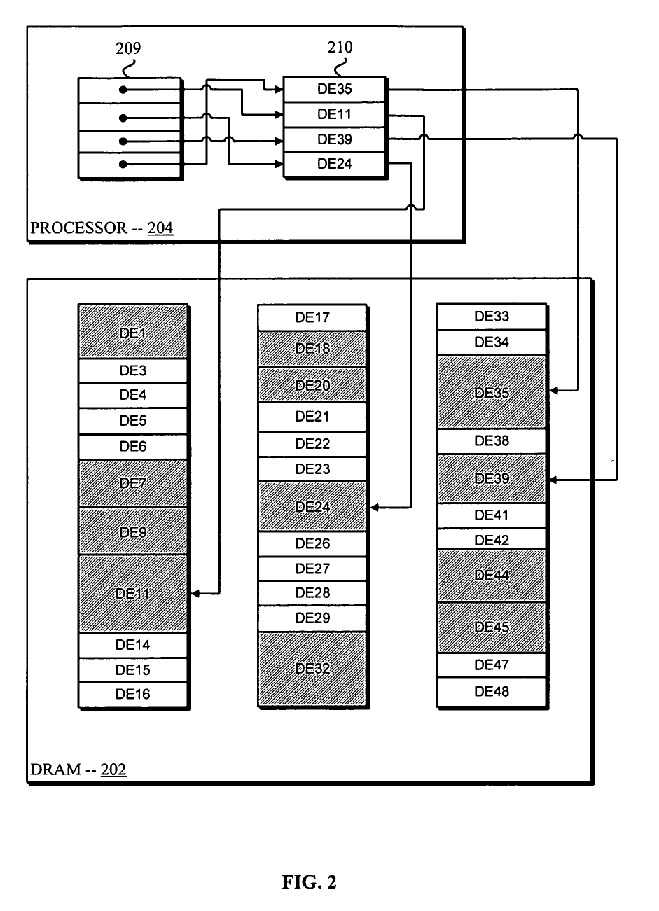

FIG. 2 shows an example of a memory caching arrangement that can be used to practice the selective caching techniques described above. Referring to FIG. 2, a memory unit 202 is shown that is characterized by relatively slow access times. For example, memory 202 may comprise dynamic random access memory (DRAM), or static random access memory (SRAM). In the example shown in FIG. 2, memory 202 stores thirty four data elements (DE1-DE4).

A processor 204 (such as a microengine 104 in FIG. 1) contains, or is closely coupled to, a local memory cache 210. In the example shown in FIG. 2, cache 210 has four entries, each of which contains a data element that corresponds to a data element stored in memory 202. Processor 204 also maintains (e.g., in software) a content addressable memory (CAM) 209 that contains cache keys or pointers to facilitate information lookup and retrieval from cache 210.

In the example shown in FIG. 2, twelve of the data elements stored in memory 202 correspond to data pipes having a capacity that is greater than a predefined threshold (indicated in FIG. 2 by shading). If the processor seeks to retrieve a given data element, the contents of the cache are first checked to see if they contain the requested data. If the data is contained in the cache (e.g., as would be the case if the processor requested data element DE35), then the data is retrieved from the cache. Otherwise, the data is retrieved from memory 202. If the requested data element corresponds to a high capacity data pipe, it is, upon retrieval from memory 202, stored in cache 210, where it replaces one of the four cache entries. In one embodiment, the new data would replace the least recently used data element in the cache.

If, on the other hand, the requested data element corresponds to a low capacity data pipe, it is simply retrieved from memory 202, and provided to the processor for further processing, with no changes being made to the cache.

In the example shown in FIG. 2, N=34, M=4, K=12, and the cache hit multiplier would be equal to 1.48, assuming R=2. It will be appreciated that the value of K will typically be related in some fashion to the value of R, and the optimal value of K for a given application can be selected in any suitable manner. For example, if the capacity, C, is set low enough, then all the data pipes will exceed that capacity, and K will be equal to N. In this case there will be no “speed up” between cached and non-cached entries (since all entries will be candidates for caching), and thus R will equal 1, as will the cache hit multiplier. This situation would also occur if all the channels had the same capacity.

It will be appreciated that FIG. 2 is provided for purposes of illustration, and not limitation, and that the systems and methods described herein can be practiced with systems that lack some of the components and features shown in FIG. 2, and/or that have other components or features that are not shown. For example, in some embodiments, cache 210 may be used without a corresponding hardware and/or software CAM 209. In other embodiments, the cache may have multiple layers. In addition, it will be appreciated that the relative dimensions of the components can be readily varied to suit the application at hand. For example, in some embodiments cache 210 may comprise sixteen, 32-bit words, and may form part of the processor's internal memory.

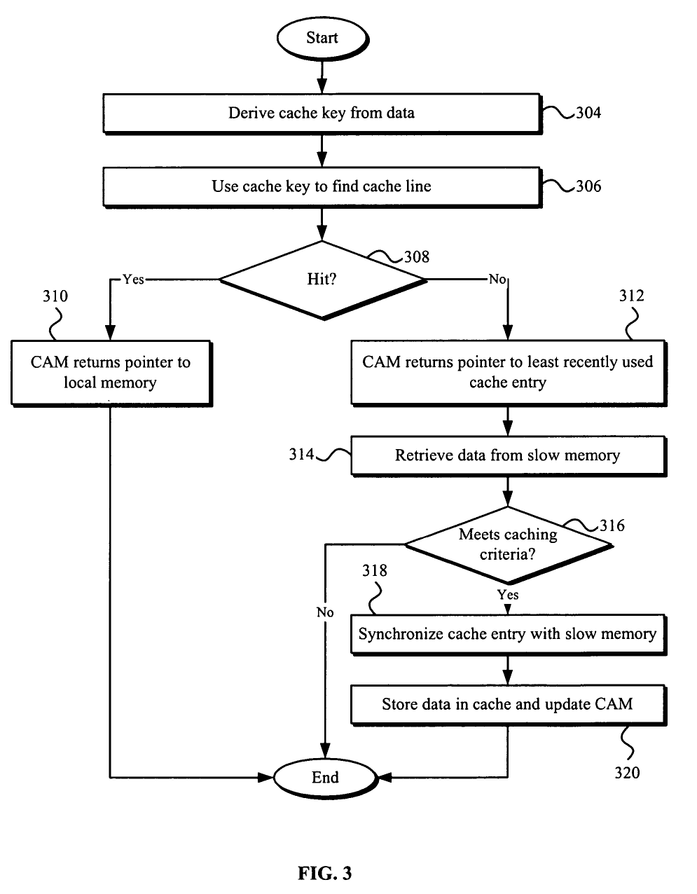

FIG. 3 is a flowchart illustrating the operation of a caching arrangement such as that shown in FIG. 2. Referring to FIG. 3, upon receiving a request to read data from DRAM 202, software running on processor 204 derives a cache key (block 304), and uses the cache key to perform a cache lookup using the processor's CAM 209 (block 306). If the data is found in the cache 210 (i.e., a “Yes” exit from block 308), the processor 204 retrieves the data from the cache 210 at the location specified by the CAM 209 (block 310). If, on the other hand, the data is not found in the cache 210 (i.e., a “No” exit from block 308), then the CAM 209 returns a pointer to the least recently used cache entry (block 312). The requested data is then retrieved from the DRAM 202 (block 314), and examined to determine if it meets the criteria for storage in the cache (block 316). For example, a determination can be made as to whether the data corresponds to a data pipe with a capacity greater than a predefined threshold. If the data does not meet the caching criteria (i.e., a “No” exit from block 316), then the data retrieved from the DRAM 202 is used by the processor 204, and written back to DRAM 202, if necessary (e.g., if it is modified by the processor), without any change being made to the cache.

If, on the other hand, the data retrieved from the DRAM 202 meets the caching criteria (i.e., a “Yes” exit from block 316), then the cache entry is synchronized with the corresponding DRAM entry (block 318), the data is stored in the cache, and the CAM is updated accordingly (block 320). It will be appreciated that in some embodiments some or all of the actions shown in blocks 318 and 320 can be performed in the background (i.e., they need not be performed at runtime before use is made of the data read from the DRAM).

It will be appreciated that FIG. 3 is provided for purposes of illustration, and not limitation, and that embodiments of the systems and methods described herein can be practiced without performing all of the actions described in connection with FIG. 3, and/or by performing additional actions that are not shown. For example, it will be appreciated that the process shown in FIG. 3 can be implemented using any suitable combination of hardware and/or software. For example, without limitation, the operations shown in FIG. 3 can be performed by processor operating under the guidance of programs stored in the processor's memory. For example, in one embodiment CAM 209 is implemented in software running on processor 204.

The systems and methods described above can be used in a variety of computer systems. For example, without limitation, the circuitry and techniques shown in FIGS. 2 and 3 can be used to provide an efficient cache in a microengine of a network processor such as that shown in FIG. 1, which may itself form part of a larger system (e.g., a network device).

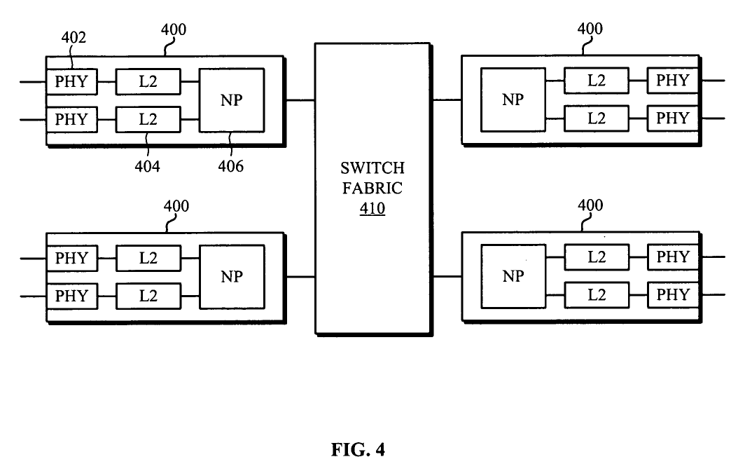

FIG. 4 shows an example of such a larger system. As shown in FIG. 4, the system features a collection of line cards or “blades” 400 interconnected by a switch fabric 410 (e.g., a crossbar or shared memory switch fabric). The switch fabric 410 may, for example, conform to the Common Switch Interface (CSIX) or another fabric technology.

Individual line cards 400 may include one or more physical layer devices 402 (e.g., optical, wire, and/or wireless) that handle communication over network connections. The physical layer devices 402 translate the physical signals carried by different network media into the bits (e.g., 1s and 0s) used by digital systems. The line cards 400 may also include framer devices 404 (e.g., Ethernet, Synchronous Optic Network (SONET), and/or High-Level Data Link Control (HDLC) framers, and/or other “layer 2” devices) that can perform operations such as error detection and/or correction on frames of data. The line cards 400 may also include one or more network processors 406 (such as network processor 100 in FIG. 1) to, e.g., perform packet processing operations on packets received via the physical layer devices 402. The caching techniques described herein can be used to enhance the efficiency of the network processor's operation.

While FIGS. 1 and 4 illustrate a network processor and a device incorporating one or more network processors, it will be appreciated that the systems and methods described herein can be implemented in other data processing contexts as well, such as in personal computers, work stations, distributed systems, and/or the like, using a variety of hardware, firmware, and/or software. It will also be appreciated that the systems and methods described herein can be used in a wide variety of applications, such as applications that perform routing protocol lookups and/or the like, or in any other application in which it is desirable to have a cache mechanism with improved average access times.

Thus, while several embodiments are described and illustrated herein, it will be appreciated that they are merely illustrative. Other embodiments are within the scope of the following claims.

1. A method comprising:
receiving a processor's request for a first data item;
determining if the first data item is stored in a cache;
if the first data item is not stored in the cache, retrieving the first data item from a memory unit;
sending the first data item to the processor for processing; and
if the first data item meets a predefined criteria, storing the first data item in the cache.

2. The method of claim 1, in which the predefined criteria includes the first data item being associated with a data pipe of at least a predefined capacity.

3. The method of claim 2, in which the predefined criteria is selected such that a cache hit multiplier takes on a value that is greater than if the predefined criteria were not applied.

4. The method of claim 3, in which the predefined capacity is chosen such that the cache hit multiplier has a value greater than one.

5. The method of claim 1, further comprising:
if the first data item does not meet the predefined criteria, processing the first data item without storing the first data item in the cache.

6. The method of claim 1, in which storing the first data item in the cache comprises overwriting a cached data item identified as being the least recently used.

7. The method of claim 1, in which determining if the first data item is stored in the cache comprises accessing a content addressable memory, the content addressable memory including one or more pointers to data in the cache.

8. The method of claim 7, in which the content addressable memory maintains an indication of a least recently used cache entry.

9. A computer program product embodied on a computer readable medium, the computer program product including instructions that, when executed by a processor, cause the processor to perform actions comprising:
receiving a processor's request for a first data item;
determining if the first data item is stored in a cache;
if the first data item is not stored in the cache, retrieving the first data item from a memory unit;
if the first data item meets a predefined criteria, storing the first data item in the cache; and
sending the first data item to the processor for processing.

10. The computer program product of claim 9, in which the predefined criteria includes the first data item being associated with a data pipe of at least a predefined capacity.

11. The computer program product of claim 9, further including instructions that, when executed by a processor, cause the processor to perform actions comprising: if the first data item does not meet the predefined criteria, storing the first data in the memory unit rather than the cache.

12. The computer program product of claim 9, in which storing the first data item in the cache comprises overwriting a cached data item identified as being least recently used.

13. The computer program product of claim 9, in which determining if the first data item is stored in the cache comprises accessing a content addressable memory, the content addressable memory including one or more pointers to data in the cache.

14. A system comprising:
a processor;
a memory unit;
a cache, the cache being characterized by faster processor access times than the memory unit, the cache being operable to store data corresponding to data streams having at least a predefined rate.

15. The system of claim 14, in which the processor comprises a microengine in a network processor.

16. The system of claim 14, in which the predefined rate is selected such that the system is characterized by a cache hit multiplier greater than one.

17. A system comprising:
a network processor comprising:
a processing core;
at least one microengine;
a cache;
a first memory unit, the first memory unit storing data for use by the at least one microengine; and
a second memory unit, the second memory unit including code that, when executed by the microengine, is operable to cause the microengine to perform actions comprising:
receiving a request for a first data item;
determining if the first data item is stored in the cache;
if the first data item is not stored in the cache, retrieving the first data item from the first memory unit; and
if the first data item meets a predefined criteria, storing the first data item in the cache.

18. The system of claim 17, in which storing the first data item in the cache comprises overwriting a cached data item identified as being least recently used.

19. The system of claim 17, in which the predefined criteria includes the first data item being associated with a data pipe having at least a predefined capacity.

20. The system of claim 17, in which determining if the first data item is stored in the cache comprises accessing a content addressable memory, the content addressable memory including one or more pointers to data in the cache.

21. The system of claim 17, in which the second memory unit further includes code that, when executed by the microengine, is operable to cause the microengine to implement a content addressable memory, the content addressable memory including a plurality of keys, the keys pointing to locations in the cache.

22. The system of claim 17, in which the second memory unit comprises random access memory internal to the microengine.

23. The system of claim 17, in which the cache comprises memory internal to the microengine.

24. The system of claim 17, in which the first memory unit and the second memory unit comprise the same dynamic random access memory unit.

25. A system comprising:
a switch fabric; and
one or more line cards comprising:
one or more physical layer components; and
one or more network processors, at least one of said network processors comprising:
a processing core;
at least one microengine;
a cache;
a first memory unit, the first memory unit storing data for use by the at least one microengine; and
a second memory unit, the second memory unit including code that, when executed by the microengine, is operable to cause the microengine to perform actions comprising:
receiving a request for a first data item;
determining if the first data item is stored in the cache;
if the first data item is not stored in the cache, retrieving the first data item from the first memory unit; and
if the first data item meets a predefined criteria, storing the first data item in the cache.

26. The system of claim 25, in which storing the first data item in the cache comprises overwriting a cached data item identified as being least recently used.

27. The system of claim 25, in which the predefined criteria includes the first data item being associated with a data pipe having at least a predefined capacity.

28. The system of claim 25, in which the second memory unit further includes a code that, when executed by the microengine, is operable to cause the microengine to implement a content addressable memory, the content addressable memory including a plurality of keys, the keys pointing to locations in the cache.

29. The system of claim 25, in which the second memory unit comprises random access memory internal to the microengine.

30. The system of claim 25, in which the cache comprises memory internal to the microengine.
